(19) United States
(12) Patent Application Publication
(10) Pub. No.: US 2008/0237512 A1
(43) Pub. Date: Oct. 2, 2008

(54) VALVE APPARATUS

(76) Inventor: Chien Chia LIN, Taoyuan Hsien (TW)

Correspondence Address: BIRCH STEWART KOLASCH & BIRCH, PO BOX 747, FALLS CHURCH, VA, 22040-0747, US

(21) Appl. No.: 12/016,880

(22) Filed: Jan. 18, 2008

(30) Foreign Application Priority Data
Mar. 30, 2007 (TW) 096111218

(51) Int. Cl. F16K 31/00

(52) U.S. Cl. 251/61.5

(57) ABSTRACT

A valve apparatus includes a body, a sleeve and a shaft. The sleeve is connected to the body by screwing. The shaft is telescoped into the sleeve. The body and the sleeve both have at least one locking portion corresponding to each other. The valve apparatus uses locking portions disposed at the junction of the body and the sleeve to lock their relative position, thereby improving the reliability of the connection.

### CROSS REFERENCE TO RELATED APPLICATIONS

This Non-provisional application claims priority under 35 U.S.C. §119(a) on Patent Application No(s). 096111218 filed in Taiwan, Republic of China on Mar. 30, 2007, the entire contents of which are hereby incorporated by reference.

### BACKGROUND OF THE INVENTION

1. Field of Invention

The invention relates to a valve apparatus and in particular, to a valve apparatus with a locking mechanism.

2. Related Art

The valve apparatus is used as a switch to control the passage and flux of a fluid such as gas or liquid. Applications of the valve apparatus are widely seen in daily life, e.g., water faucet, water channel valve, etc. The valve apparatus is also largely used in the industry, such as the stop valve, tuning valve and water power control valve.

As shown in FIG. 1, a conventional valve apparatus 1 mainly includes a valve body 11, a sleeve 12, a shaft 13 and a rubber pad 14. The valve body 11 is the primary element for conveying the fluid. The shaft 13 is telescoped into the sleeve 12. The rubber pad 14 is disposed in a fixing groove 121 of the sleeve 12 to prevent fluid leakage. After the rubber pad 14, the shaft 13 and the sleeve 12 are assembled together, the sleeve 12 is combined with the valve body 11. Thus, the passage and flux of the fluid can be controlled by moving the shaft 13 up and down.

The connection of the valve body 11 and the sleeve 12 is usually achieved by thermal or ultrasonic welding. Although this method can ensure that the user cannot arbitrarily take apart the valve, the welding process involves the use of a heater or ultrasonic welding machine in the manufacturing process. This increases the required equipment, working time, and total cost. In addition, this method will destroy the properties of the original material, so the quality control is difficult. Therefore, this conventional method cannot completely prevent the fluid from leaking.

Therefore, it is an important subject to provide a valve apparatus that does not require additional machining equipment for assembly and can prevent the user from arbitrarily take it apart.

### SUMMARY OF THE INVENTION

In view of the foregoing, the invention is to provide a valve apparatus without using additional machining equipment for assembly and capable of prevent the user from arbitrarily take it apart.

To achieve the above, the invention discloses a valve apparatus including a body, a sleeve and a shaft. The sleeve is connected to the body, and the shaft is telescoped into the sleeve. Each of the body and the sleeve has at least one locking portion matching with each other.

As mentioned above, the valve apparatus of the invention uses locking portions disposed at the junction of the body and the sleeve to lock their relative position, thereby improving the reliability of the connection. The invention can indeed prevent the user from dangers due to arbitrary disassembly. In addition, the invention also uses the design of screwing for the assembly. No additional equipment, such as a heater or ultrasonic welding machine, is required. Therefore, the cost and working time can be both reduced.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic view of a conventional valve apparatus;

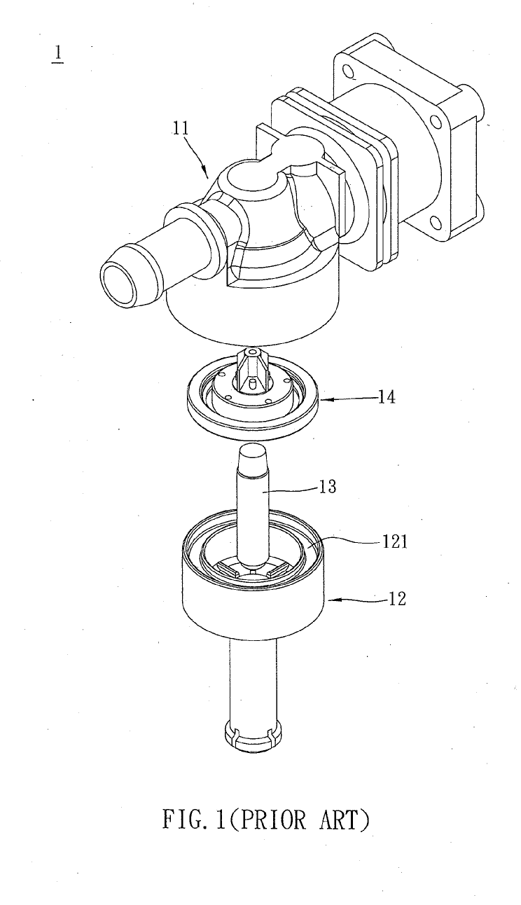

FIG. 2 is a three-dimensional view of a valve apparatus according to an embodiment of the invention; and

FIG. 3 is a cross-sectional view of a portion of the electromagnetic valve apparatus according to the embodiment of the invention.

### DETAILED DESCRIPTION OF THE INVENTION

The present invention will be apparent from the following detailed description, which proceeds with reference to the accompanying drawings, wherein the same references relate to the same elements.

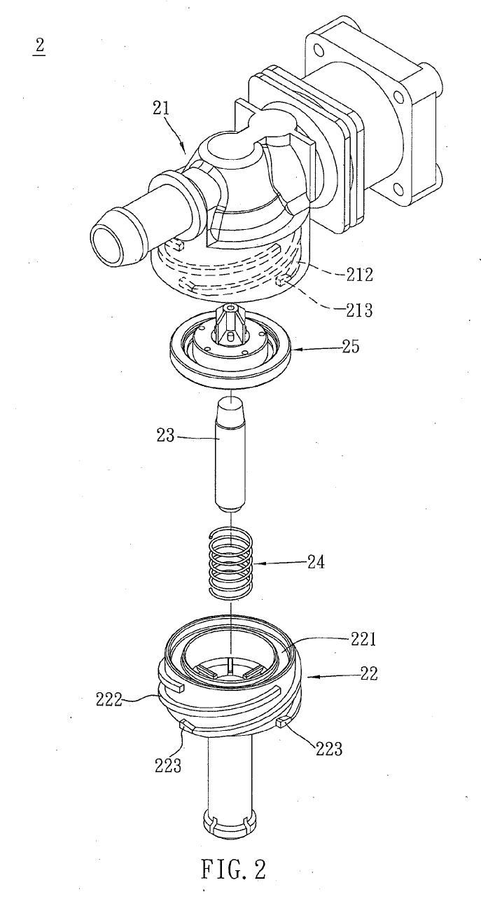

As shown in FIG. 2, a valve apparatus 2 according to an embodiment of the invention includes a body 21, a sleeve 22, a shaft 23, an elastic element 24 and a sealing pad 25. The shaft 23 is telescoped into the sleeve 22 and can be controlled to move up and down by electromagnetic or mechanical force. The elastic element 24 is disposed inside the sleeve 22 and against the shaft 23 for providing the shaft 23 an elastic force. The sealing pad 25 is disposed in a fixing groove 221 of the sleeve 22, and located at the junction between the body 21 and the sleeve 22. In this embodiment, the sealing pad 25 is ring-shaped, and is made of rubber or plastic to prevent fluid leakage.

In this embodiment, the body 21 and the sleeve 22 are connected by screwing, such as, through a screw with a single-round thread. The body 21 has at least a first thread 212, and the sleeve 22 has at least a second thread 222 corresponding to the first thread 212. The first thread 212 and the second thread 222 are not restricted to inner threads or outer threads. In this embodiment, for example, the first thread 212 is an inner thread, and the second thread 222 is an outer thread. Alternatively, the first thread 212 can be an outer thread and the second thread 222 can be an inner thread.

In addition, the body 21 has a locking portion 213, and the sleeve 22 also has at least one locking portion 223. The locking portions 213 and 223 are disposed corresponding to each other. In this embodiment, the locking portion 213 is disposed on one end of the first thread 212, and the locking portion 223 is disposed on the corresponding end of the second thread 222. The combination of the locking portions 213 and 223 prevents the sleeve 22 from departing from the body 21.

In this embodiment, the locking portion 223 is a protruding part, and the locking portion 213 is a concave part. To lock the sleeve 22 onto the body 21, the manufacturer puts the sleeve 22 in the body 21 and turns the sleeve 22 or the body 21 following the threads. The manufacturer can of course turn both the sleeve 22 and the body 21 at the same time. The turning force combines the locking portion 223 of the sleeve 22 and the locking portion 213 of the body 21. By locking the locking portions 213 and 223, the sleeve 22 and the valve 21 can be prevented from departing from each other. The user is also prevented from being hurt due to arbitrary disassembly.

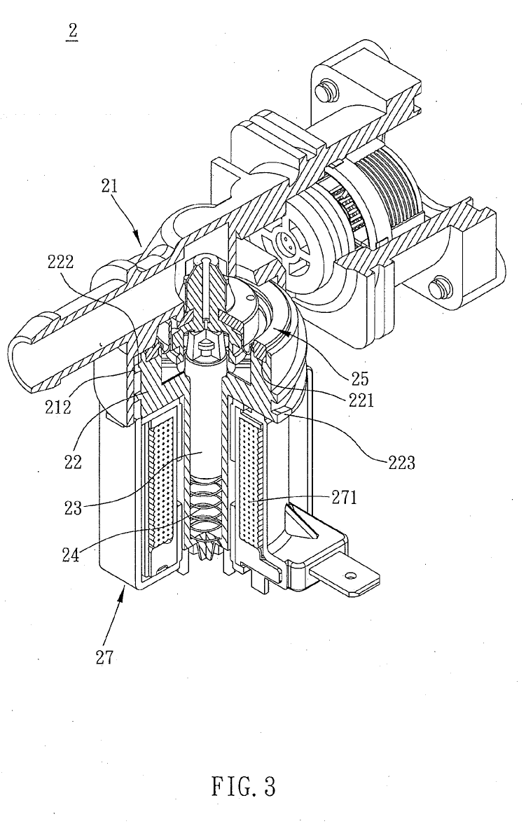

Referring to FIG. 3, the valve apparatus 2 in this embodiment is, for example, an electromagnetic valve apparatus. The valve apparatus 2 has an electromagnetic structure 27 with a magnetic body 271, such as an annular magnet or electromagnet mounted around the shaft 23. When an electrical current flows through the electromagnetic structure 27, the magnetic body 271 and the shaft 23 produce a magnetic interaction. Accordingly, the shaft 23 moves downward to open the valve, allowing the fluid to pass through. On the other hand, when the valve apparatus 2 is not provided with an electrical current, the shaft 23 does not experience any magnetic attraction. The restoring force provided by an elastic element 24, such as a spring, pushes the shaft 23 upward. Therefore, the valve is closed so that the fluid is not allowed to pass. As mentioned above, the invention provides a mechanism to control the passage and flux of the fluid.

In summary, the valve apparatus of the invention uses locking portions disposed at the junction of the body and the sleeve to lock their relative position, thereby improving the reliability of the connection. The invention can indeed prevent the user from dangers due to arbitrary disassembly. In addition, the invention also uses the design of screwing for the assembly. No additional equipment, such as a heater or ultrasonic welding machine, is required. Therefore, the cost and working time can be both reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A valve apparatus comprising:
a body;
a sleeve connected to the body; and
a shaft telescoped into the sleeve, wherein the body and the sleeve both have at least one locking portion matching with each other.

2. The valve apparatus of claim 1, wherein the body and the sleeve are connected by a screw with a single-round thread.

3. The valve apparatus of claim 1, wherein the body has at least one first thread and the sleeve has at least one second thread corresponding to the first thread.

4. The valve apparatus of claim 3, wherein the locking portions are disposed on corresponding ends of the first thread and the second thread, respectively.

5. The valve apparatus of claim 3, wherein the first thread is an inner thread and the second thread is an outer thread.

6. The valve apparatus of claim 3, wherein the first thread is an outer thread and the second thread is an inner thread.

7. The valve apparatus of claim 1, wherein the locking portions are a depressing part and a protruding part, respectively.

8. The valve apparatus of claim 1, further comprising an elastic element disposed between the shaft and the sleeve.

9. The valve apparatus of claim 8, wherein the elastic element is a spring.

10. The valve apparatus of claim 1, further comprising a sealing pad disposed at a junction between the body and the sleeve.

11. The valve apparatus of claim 10, wherein the sealing pad is ring-shaped.

12. The valve apparatus of claim 10, wherein the sealing pad is made of rubber or plastic material.

13. The valve apparatus of claim 1, being a mechanical valve apparatus.

14. The valve apparatus of claim 1, being an electromagnetic valve apparatus.

15. The valve apparatus of claim 14, further comprising an electromagnetic structure mounted around one end of the sleeve, wherein the electromagnetic structure and the body are disposed at opposite ends of the sleeve, respectively.

16. The valve apparatus of claim 15, wherein the electromagnetic structure comprises a magnetic body surrounding the shaft.

17. The valve apparatus of claim 16, wherein the magnetic body is an annular magnet or an electromagnet.
